(19) United States
(12) Patent Application Publication
(10) Pub. No.: US 2015/0046784 A1
(43) Pub. Date: Feb. 12, 2015

(54) EXTRACTION DEVICE FOR COMPOSITE GRAPH IN FIXED LAYOUT DOCUMENT AND EXTRACTION METHOD THEREOF

(71) Applicants: PEKING UNIVERSITY FOUNDER GROUP CO., LTD., BEIJING (CN); FOUNDER APABI TECHNOLOGY LIMITED, BEIJING (CN); PEKING UNIVERSITY, BEIJING (CN)

(72) Inventors: Canhui XU, Beijing (CN); Zhi Tang, Beijing (CN); Xin Tao, Beijing (CN); Cao Shi, Beijing (CN)

(73) Assignees: PEKING UNIVERSITY FOUNDER GROUP CO., LTD., BEIJING (CN); PEKING UNIVERSITY, BEIJING (CN); FOUNDER APABI TECHNOLOGY LIMITED, BEIJING (CN)

(21) Appl. No.: 14/104,064

(22) Filed: Dec. 12, 2013

(30) Foreign Application Priority Data
Aug. 8, 2013 (CN) 201310343908.8

(51) Int. Cl. G06F 17/21

(52) U.S. Cl. CPC G06F 17/211
USPC 715/209

(57) ABSTRACT

An extraction device for the composite graph in a fixed layout document comprising: a document parsing unit, for parsing the fixed layout document, and determining the primitives of the fixed layout document and their types; a layer generation unit, for extracting text primitives so as to form a text layer, and using the rest non-text primitives to form a non-text layer; a page analysis unit, for processing the text layer and the non-text layer with page analyses respectively; a block generation unit, for generating a text block in the text layer and a graph block in the non-text layer; a correlation block determination unit, for determining text blocks correlating to every graph block and merging those correlated text blocks and graph blocks into a composite graph block; an identifier storage unit, for storing the identifiers of all the primitives contained in the composite graph block.

### CROSS-REFERENCE TO RELATED APPLICATIONS

This application claims priority to Chinese Patent Application No. 201310343908.8, filed on Aug. 8, 2013 and entitled “Extraction device for composite graph in fixed layout document and extraction method thereof”, which is incorporated herein by reference in its entirety.

### BACKGROUND

1. Technical Field

The present invention generally relates to a technology of format transformation of the electronic documents, in particular, relates to an extraction device for composite graph in a fixed layout document and an extraction method for composite graph in a fixed layout document.

### 2. Technical Backgrounds

A scanner or a camera is usually used in transforming a paper document into an electronic document to obtain the digital image of the documents. After a serial of image processings, the characters in those digital images are partitioned out and input into an OCR (Optical Character Recognition) system. However, a fixed layout document generated directly from document processing software, such as typesetting software, is replacing the image document transformed from the paper document to become the main source of the digital publication.

Automatic extraction of structure information mainly includes page analysis and page understanding. The relevant researches all hang on the extraction of physical structure from the image document page. The research focusing on the OCRed or born-digital fixed layout document is under development. The complexity and diversity of the document page layout lead to a common difficulty in accurate illustration segmentation, especially the illustration surrounded by text. Furthermore, in a fixed layout document, the composite graph consisting of sub-objects, such as a plurality of sub-image, a large number of path operations, text primitives, and etc., cannot be correctly extracted out as a whole in a reversed engineering page structure analysis. Therefrom the fixed layout document not only requires a lot of paths to define thereby causing redundancy in a great extent, but also disadvantages the normal display of the composite graph when the fixed layout document is adapted to a reflowable layout. As a result, the prior art cannot satisfy the growing needs for electronic reading in practice.

Therefore, there exists a need for new techniques of extracting composite graph from the fixed layout document to allow an accurate extraction of composite graph in a complex page layout, especially in a graph-text mixing page.

### SUMMARY

With respect to the above technical problems, the present invention provides a new extraction technique of obtaining composite graph in the fixed layout document, which enables an accurate extraction of composite graph in a complex page layout, especially in a graph-text mixing page.

Based on this new technique, according to an aspect of the present invention, an extraction device for the composite graph in a fixed layout document is provided. The extraction device comprises: a document parsing unit, for parsing the fixed layout document, and determining the primitives of the fixed layout document and their types; a layer generation unit, for extracting text primitives so as to form a text layer, and using the rest non-text primitives to form a non-text layer; a page analysis unit, for processing the text layer and the non-text layer with page analyses respectively; a block generation unit, for generating a text block in the text layer and a graph block in the non-text layer, based on the processing results of the page analyses conducted by the page analysis unit; a correlation block determination unit, for determining text blocks correlating to every graph block and merging those correlated text blocks and graph blocks into a composite graph block; an identifier storage unit, for storing the identifiers of all the primitives contained in the composite graph block.

In this technical solution, after the parsing of the fixed layout document, the primitives obtained therefrom form the text layer (including text primitives) and the non-text layer (including non-text primitives) respectively, thereafter every layer is undergone a block classification respectively, and finally a composite graph block is decided by means of the relationship between blocks, so as to accomplish the composite graph block segmentation and to ensure a proper processing of the text primitives and the non-text primitives.

When multiple layers are formed, in particular, a possible solution is to extract all the text primitives at first to form a text layer, and then take the rest elements with the text primitives filtered out as non-text primitives.

This solution can efficiently parse the page under complex conditions, for example, a graph-text mixing page, a page containing images and legend information, and etc., thereby accurately partitioning the composite graph block therein. The composite graph block may include one or more than one composite graph(s), or may include characters, such as caption or legend and so on, in or surrounding the composite graph. By recording all the identifiers of primitives forming the composite graph block, for example, the primitive ID, the composite graph block is mapped by these primitive IDs so as to accomplish the division of this block from the whole page and facilitate other processings, such as a reflowable layout.

In the above technical solution, preferably, the page analysis unit comprises: a clustering process sub-unit, for clustering the text primitives in the text layer so as to classify the text primitives; a text block generation sub-unit, in the case where there are many text primitives in the same class, for assembling these text primitives of the same class as a text primitive set and taking the minimum bounding rectangle of the text primitive set as one of the text blocks, when the corresponding minimum bounding rectangles intersect or the spacing distance thereof is less than the preset distance.

This technical solution may efficiently classify the text primitives by a clustering arithmetic processing based on neighborhood features similarities of the text primitives within a page, so as to determine each text primitive should belong to the body text portion or the composite graph portion. By means of a judgment to the distance and corresponding processing, the forming relation of multiple text primitives are determined, for example, to form a text block which corresponds to a complete character.

In the above technical solution, preferably, the page analysis unit comprises: a texture feature obtaining sub-unit, for obtaining the texture features of the non-text primitives in the non-text layer; a connect-region detection sub-unit, for detecting the connected non-text object regions in the non-text layer according to the texture features and a preset feature threshold; a graph block generation sub-unit, regarding multiple connected non-text object regions as mentioned above, for assembling these multiple connected non-text object regions as a region set and taking the minimum bounding rectangle of the region set as the graph block, when the corresponding minimum bounding rectangles intersect or the spacing distance thereof is less than the preset distance.

This technical solution, by means of connect-region detection on non-text objects in a page based on the texture analysis and morphological processing, identifies the connected non-text object region in a page, which region is actually corresponding to an image or a part of the image in the page; further by means of a judgment to the distance and corresponding processing, several connected regions constituting one image may be merged such that one complete image is identified.

In the above technical solution, preferably, the page analysis unit further comprises: a hole filling sub-unit, for filling the holes present in the connected non-text object regions.

By filling the holes present in the connected non-text object regions, this technical solution is able to process the corresponding regions as a whole object and avoid difficulties and possible accidents during the processing caused by the holes.

In the above technical solution, preferably, the correlation block determination unit comprises: a positional relation detection sub-unit, for detecting the positional relation between the graph block and the text block, wherein if the specified graph block intersects with at least one text block or the spacing distance between the specified graph block and the at least one text block is less than the preset distance, then the at least one text block is determined to be correlated to the specified graph block.

In this technical solution, since the graph is usually accompanied with some literal description, for example, figure caption, legend in graph, and so on, these texts are correlated with the graph so that the former and the latter should be partitioned into the same block. By virtue of the above processings, the composite graph block partitioned thereby is more accurate.

The above technical solution, preferably, further includes: an image generation unit, for generating image file with the composite graph blocks; an image storage unit, for storing those image files.

In this technical solution, the divided composite graph blocks are stored directly in the form of image files, in such a way it is not necessary to manage the primitive IDs, especially when these composite graph blocks include a great number of primitives. It is obvious that this processing method using image files advantages the increasing of processing efficiency.

According to another aspect of the invention, an extraction method of composite graph in a fixed layout document is further proposed, comprising: step 202, parsing the fixed layout document to determine the primitives constituting the fixed layout document and the types of these primitives; step 204, extracting text primitives to form a text layer, and using the rest non-text primitives to form a non-text layer; step 206, having the text layer and the non-text layer undergone page analyses respectively, so as to generate a text block in the text layer and a graph block in the non-text layer; step 208, determining the text block correlated with each graph block, so as to merge them into a composite graph block; step 210, storing all the identifiers of primitives contained in the composite graph block.

In this technical solution, after the parsing of the fixed layout document, the primitives obtained therefrom form the text layer (including text primitives) and the non-text layer (including non-text primitives) respectively, thereafter every layer is undergone a block classification respectively, and finally a composite graph block is decided by means of the relationship between blocks, so as to accomplish the composite graph block segmentation and to ensure a proper processing of the text primitives and the non-text primitives. When multiple layers are formed, in particular, a possible solution is to extract all the text primitives at first to form a text layer, and then take the rest elements with the text primitives filtered out as non-text primitives. This solution can efficiently parse the page under complex conditions, for example, a graph-text mixing page, a page containing images and legend information, and etc., thereby accurately partitioning the composite graph block therein. The composite graph block may include one or more than one composite graph(s), or may include characters, such as caption or legend and so on, in or surrounding the composite graph. By recording all the identifiers of primitives forming the composite graph block, for example, the primitive ID, the composite graph block is mapped by these primitive IDs so as to accomplish the division of this block from the whole page and facilitate other processings, such as a reflowable layout.

In the above technical solution, preferably, the step of processing the text layer with page analysis comprises: clustering the text primitives in the text layer so as to classify the text primitives, wherein in the case where there are many text primitives in the same class, assembling these text primitives of the same class as a text primitive set and taking the minimum bounding rectangle of the text primitive set as one of the text blocks if the corresponding minimum bounding rectangles intersect or the spacing distance thereof is less than the preset distance.

This technical solution may efficiently classify the text primitives by a clustering arithmetic processing based on neighborhood features similarities of the text primitives within a page, so as to determine each text primitive should belong to the body text portion or the composite graph portion. By means of a judgment to the distance and corresponding processing, the forming relation of multiple text primitives are determined, for example, to form a text block which corresponds to a complete character.

In the above technical solution, preferably, the step of processing the non-text layer with page analysis comprises: obtaining the texture features of the non-text primitives in the non-text layer, and detecting the connected non-text object regions in the non-text layer according to the preset feature threshold, wherein regarding multiple connected non-text object regions as mentioned above, assembling these multiple connected non-text object regions as a region set and taking the minimum bounding rectangle of the region set as the graph block if the corresponding minimum bounding rectangles intersect or the spacing distance thereof is less than the preset distance.

This technical solution, by means of connect-region detection on non-text objects in a page based on the texture analysis and morphological processing, identifies the connected non-text object region in a page, which region is actually corresponding to an image or a part of the image in the page; further by means of a judgment to the distance and corresponding processing, several connected regions constituting one image may be merged such that one complete image is identified.

The above technical solution, preferably, further comprises: filling the holes present in the connected non-text object regions.

By filling the holes present in the connected non-text object regions, this technical solution is able to process the corresponding regions as a whole object and avoid difficulties and possible accidents during the processing brought by the holes.

In the above technical solution, preferably, the step of determining the text blocks correlated to each graph block comprises: detecting the positional relation between the graph block and the text block, if the specified graph block intersects with at least one text block or the spacing distance between the specified graph block and the at least one text block is less than the preset distance, then the at least one text block is determined to be correlated to the specified graph block.

In this technical solution, since the graph is usually accompanied with some literal description, for example, figure caption, legend in graph, and so on, these texts are correlated with the graph so that the former and the latter should be partitioned into the same block. By virtue of the above processings, the composite graph block partitioned thereby is more accurate.

The above technical solution, preferably, further includes: storing the composite graph block aforementioned as image file.

In this technical solution, the divided composite graph blocks are stored directly in the form of image files, in such a way it is not necessary to manage the primitive IDs, especially when these composite graph blocks include a great number of primitives. It is obvious that this processing method using image files advantages the increasing of processing efficiency.

The disclosure provides a computer-readable medium having computer-executable instructions that, when executed by a computer, performs the above extraction method for the composite graph in a fixed layout document.

By virtue of the above technical solution, the accurate extraction of composite graph is accomplished in a complex page layout, especially in a graph-text mixing page layout.

### BRIEF DESCRIPTION OF THE DRAWINGS

FIG. 1 is a block diagram of the extraction device for the composite graph in a fixed layout document according an embodiment of the present invention;

FIG. 2 is a flow diagram of the extraction method of the composite graph in a fixed layout document according an embodiment of the present invention;

FIG. 3 is a detailed flow diagram for extracting the composite graph in a fixed layout document according an embodiment of the present invention;

FIGS. 4A-4D are schematic diagrams for extracting composite graph in a fixed layout document according to one embodiment of the present invention;

FIGS. 5A-5D are schematic diagrams for extracting composite graph in a fixed layout document according to another embodiment of the present invention.

### DETAILED DESCRIPTION

In order for a clearer understanding of the above objectives, features and advantages of the present invention, the present invention is further described in details with the Figures and particular embodiments. It is appreciated that the embodiments of the present application and features in those embodiments may combine with each other, if no conflicts exist.

Many specific details are shown in the following description to facilitate a full understanding of the present invention. However, the present invention is able to be realized by different methods other than those described herein. As a result, the present invention is not construed to be limited to the following disclosed embodiments.

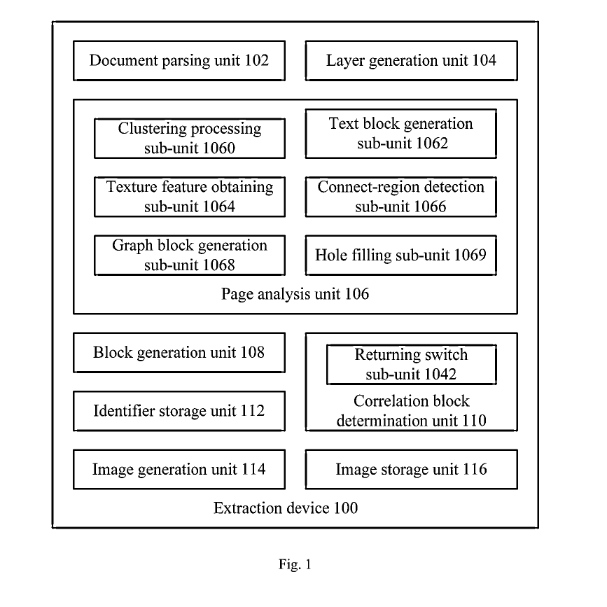

FIG. 1 is a block diagram of the extraction device for the composite graph in a fixed layout document according an embodiment of the present invention.

As shown in FIG. 1, the extraction device 100 for the composite graph in a fixed layout document according to an embodiment of the present invention comprises: a document parsing unit 102, for parsing the fixed layout document, and determining the primitives of the fixed layout document and their types; a layer generation unit 104, for extracting text primitives so as to form a text layer, and using the rest non-text primitives to form a non-text layer; a page analysis unit 106, for processing the text layer and the non-text layer with page analyses respectively; a block generation unit 108, for generating a text block in the text layer and a graph block in the non-text layer, based on the processing results of the page analyses conducted by the page analysis unit 106; a correlation block determination unit 110, for determining text blocks correlating to every graph block and merging those correlated text blocks and graph blocks into a composite graph block; an identifier storage unit 112, for storing the identifiers of all the primitives contained in the composite graph block.

In this technical solution, after the parsing of the fixed layout document, the primitives obtained therefrom form the text layer (including text primitives) and the non-text layer (including non-text primitives) respectively, thereafter every layer is undergone a block classification respectively, and finally a composite graph block is decided by means of the relationship between blocks, so as to accomplish the composite graph block segmentation and to ensure a proper processing of the text primitives and the non-text primitives. When multiple layers are formed, in particular, a possible solution is to extract all the text primitives at first to form a text layer, and then take the remaining elements with the text primitives filtered out as non-text primitives. This solution can efficiently parse the page under complex conditions, for example, a graph-text mixing page, a page containing images and legend information, and etc., thereby accurately partitioning the composite graph block therein. The composite graph block may include one or more than one composite graph(s), or may include characters, such as caption or legend and so on, in or surrounding the composite graph. By recording all the identifiers of primitives forming the composite graph block, for example, the primitive ID, the composite graph block is mapped by these primitive IDs so as to accomplish the division of this block from the whole page and facilitate other processings, such as a reflowable layout.

In the above technical solution, preferably, the page analysis unit 106 comprises: a clustering process sub-unit 1060, for clustering the text primitives in the text layer so as to classify the text primitives; a text block generation sub-unit 1062, in the case where there are many text primitives in the same class, for assembling these text primitives of the same class as a text primitive set and taking the minimum bounding rectangle of the text primitive set as one of the text blocks, when the corresponding minimum bounding rectangles intersect or the spacing distance thereof is less than the preset distance.

This technical solution may efficiently classify the text primitives by a clustering arithmetic processing based on neighborhood features similarities of the text primitives within a page, so as to determine each text primitive should belong to the body text portion or the composite graph portion. By means of a judgment to the distance and corresponding processing, the forming relation of multiple text primitives are determined, for example, to form a text block which corresponds to a complete character.

In the above technical solution, preferably, the page analysis unit 106 comprises: a texture feature obtaining sub-unit 1064, for obtaining the texture features of the non-text primitives in the non-text layer; a connect-region detection sub-unit 1066, for detecting the connected non-text object regions in the non-text layer according to the texture features and a preset feature threshold; a graph block generation sub-unit 1068, regarding multiple connected non-text object regions as mentioned above, for assembling these multiple connected non-text object regions as a region set and taking the minimum bounding rectangle of the region set as the graph block, when the corresponding minimum bounding rectangles intersect or the spacing distance thereof is less than the preset distance.

This technical solution, by means of connect-region detection on non-text objects in a page based on the texture analysis and morphological processing, identifies the connected non-text object region in a page, which region is actually corresponding to an image or a part of the image in the page; further by means of a judgment to the distance and corresponding processing, several connected regions constituting one image may be merged such that one complete image is identified.

In the above technical solution, preferably, the page analysis unit 106 further comprises: a hole filling sub-unit 1069, for filling the holes present in the connected non-text object regions.

By filling the holes present in the connected non-text object regions, this technical solution is able to process the corresponding regions as a whole object and avoid difficulties and possible accidents during the processing brought by the holes.

In the above technical solution, preferably, the correlation block determination unit 110 comprises: a positional relation detection sub-unit 1100, for detecting the positional relation between the graph block and the text block, wherein if the specified graph block intersects with at least one text block or the spacing distance between the specified graph block and the at least one text block is less than the preset distance, then the at least one text block is determined to be correlated to the specified graph block.

In this technical solution, since the graph is usually accompanied with some literal description, for example, figure caption, legend in graph, and so on, these texts are correlated with the graph so that the former and the latter should be partitioned into the same block. By virtue of the above processings, the composite graph block partitioned thereby is more accurate.

The above technical solution, preferably, further includes: an image generation unit 114, for generating image file with the composite graph block; an image storage unit 116, for storing those image files.

In this technical solution, the divided composite graph blocks are stored directly in the form of image files, in such a way it is not necessary to manage the primitive IDs, especially when these composite graph blocks include a great number of primitives. It is obvious that this processing method using image files advantages the increasing of processing efficiency.

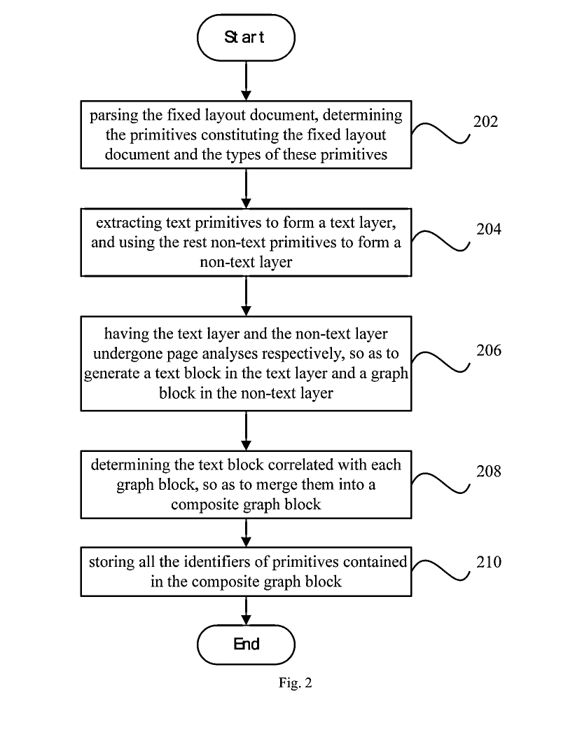

FIG. 2 is a flow diagram of the extraction method of the composite graph in a fixed layout document according an embodiment of the present invention.

As shown in FIG. 2, the extraction method of composite graph in a fixed layout document according to an embodiment of the present invention, comprises: step 202, parsing the fixed layout document to determine the primitives constituting the fixed layout document and the types of these primitives; step 204, extracting text primitives to form a text layer, and using the rest non-text primitives to form a non-text layer; step 206, having the text layer and the non-text layer undergone page analyses respectively, so as to generate a text block in the text layer and a graph block in the non-text layer; step 208, determining the text block correlated with each graph block, so as to merge them into a composite graph block; step 210, storing all the identifiers of primitives contained in the composite graph block.

In this technical solution, after the parsing of the fixed layout document, the primitives obtained therefrom form the text layer (including text primitives) and the non-text layer (including non-text primitives) respectively, thereafter every layer is undergone a block classification respectively, and finally a composite graph block is decided by means of the relationship between blocks, so as to accomplish the composite graph block segmentation and to ensure a proper processing of the text primitives and the non-text primitives. When multiple layers are formed, in particular, a possible solution is to extract all the text primitives at first to form a text layer, and then take the rest elements with the text primitives filtered out as non-text primitives. This solution can efficiently parse the page under complex conditions, for example, a graph-text mixing page, a page containing images and legend information, and etc., thereby accurately partitioning the composite graph block therein. The composite graph block may include one or more than one composite graph(s), or may include characters, such as caption or legend and so on, in or surrounding the composite graph. By recording all the identifiers of primitives forming the composite graph block, for example, the primitive ID, the composite graph block is mapped by these primitive IDs so as to accomplish the division of this block from the whole page and facilitate other processings, such as a reflowable layout.

In the above technical solution, preferably, the step of processing the text layer with page analysis comprises: clustering the text primitives in the text layer so as to classify the text primitives, wherein in the case where there are many text primitives in the same class, assembling these text primitives of the same class as a text primitive set and taking the minimum bounding rectangle of the text primitive set as one of the text blocks if the corresponding minimum bounding rectangles intersect or the spacing distance thereof is less than the preset distance.

This technical solution may efficiently classify the text primitives by a clustering arithmetic processing based on neighborhood features similarities of the text primitives within a page, so as to determine each text primitive should belong to the body text portion or the composite graph portion. By means of a judgment to the distance and corresponding processing, the forming relation of multiple text primitives are determined, for example, to form a text block which corresponds to a complete character.

In the above technical solution, preferably, the step of processing the non-text layer with page analysis comprises: obtaining the texture features of the non-text primitives in the non-text layer, and detecting the connected non-text object regions in the non-text layer according to the preset feature threshold, wherein regarding multiple connected non-text object regions as mentioned above, assembling these multiple connected non-text object regions as a region set and taking the minimum bounding rectangle of the region set as the graph block if the corresponding minimum bounding rectangles intersect or the spacing distance thereof is less than the preset distance.

This technical solution, by means of connect-region detection on non-text objects in a page based on the texture analysis and morphological processing, identifies the connected non-text object region in a page, which region is actually corresponding to an image or a part of the image in the page; further by means of a judgment to the distance and corresponding processing, several connected regions constituting one image may be merged such that one complete image is identified.

The above technical solution, preferably, further comprises: filling the holes present in the connected non-text object regions.

By filling the holes present in the connected non-text object regions, this technical solution is able to process the corresponding regions as a whole object and avoid difficulties and possible accidents during the processing brought by the holes.

In the above technical solution, preferably, the step of determining the text blocks correlated to each graph block comprises: detecting the positional relation between the graph block and the text block, if the specified graph block intersects with at least one text block or the spacing distance between the specified graph block and the at least one text block is less than the preset distance, then the at least one text block is determined to be correlated to the specified graph block.

In this technical solution, since the graph is usually accompanied with some literal description, for example, figure caption, legend in graph, and so on, these texts are correlated with the graph so that the former and the latter should be partitioned into the same block. By virtue of the above processings, the composite graph block partitioned thereby is more accurate.

The above technical solution, preferably, further includes: storing the composite graph block aforementioned as image file.

In this technical solution, the divided composite graph blocks are stored directly in the form of image files, in such a way it is not necessary to manage the primitive IDs, especially when these composite graph blocks include a great number of primitives. It is obvious that this processing method using image files advantages the increasing of processing efficiency.

FIG. 3 is a detailed flow diagram for extracting the composite graph in a fixed layout document according an embodiment of the present invention.

As shown in FIG. 3, the particular process for extracting composite graph in a fixed layout document according to an embodiment of the present invention comprises:

Step 302, using a parsing engine to parse the original fixed layout document.

Step 304, obtaining the primitives included in the fixed layout document, based on the parsing results.

Step 306, deciding the types of the primitives, for example, distinguishing according to the parsed primitive type, wherein if the type is text, then obtaining this text primitive and entering step 310, otherwise entering step 308.

Step 308, conducting corresponding processing according to the type of the primitive.

Step 310, processing the page into layers; in particular, on the basis of the text primitives obtained in step 306, forming a text layer with all the text primitives, and then forming a non-text layer with the rest primitives after all the text primitives are filtered out.

Certainly, this method of obtaining, layering, filtering and re-layering the text primitives is only one of the methods for constructing a layer. In fact, there are other ways to form a layer, for example, by obtaining the non-text primitives to achieve the purpose, or by obtaining the text primitives and the non-text primitives respectively so as to form the respective layers at the same time, and so on.

The text layer and the non-text layer are respectively processed at below, wherein from step 312 to step 316, the text layer is processed, and from step 318 to step 322, the non-text layer is processed. The detailed descriptions go on as following.

Step 312, constructing a neighborhood relation of the Delaunay triangulation. In particular, the centroid of the bounding rectangle of the text primitives in a page is taken as the vertex V to construct the neighborhood relation of the text primitives in the page G=(V,E) with the use of the Delaunay triangulation.

Step 314, clustering the text primitives with graph-based the union-find algorithm, in particular, comprising:

1. Calculating the weight w(vᵢ,vⱼ) of the edge E connecting adjacent nodes vᵢ and vⱼ in the constructed undirected graph:

$$w ( {v}_{i} , {v}_{j} ) = {\sum }_{k}^{ } {λ}_{k} {f}_{k} ( {v}_{i} , {v}_{j} )$$

wherein, k represents the dimension of the characteristic similarity function fₖ(vᵢ,vⱼ) of the adjacent nodes vᵢ and vⱼ, and the dimension of the characteristic function may be selected depending on different application scenarios, and λₖ represents the selected weight coefficient of the characteristic function.
2. Clustering all the text primitives, and defining the intra-cluster distance Int(C) and the inter-cluster distance Dif (Cₗ,C_{Z}) of the node sets according to the statistical distribution of the nodes within a page. In particular, the clustering procedure adopts the following graph-based union-find algorithm:
1) consider each node (i.e. each text primitive) within the page as a set, traversing an edge of the undirected graph;
2) find which set the two nodes connected by the edge belong to respectively;
3) if the inter-cluster distance of the node sets C₁ and C₂ satisfies Dif (Cᵢ,C₂)≦min(Int(C₁),Int(C₂)), then merge these two sets to form a new set C₁ and delete set C₁ and set C₂; however if Dif(Cₗ, C₂)>min(Int(C₁),Int(C₂)), then skip the union operation;
4) traverse all the edges to complete the clustering of the text primitives, and calculate the bounding box of the close and homogenous text primitive sets.

Step 318, calculating the texture feature, and detecting the connected region, in particular, comprising: calculating the image texture feature of this layer, adopting the grey comatrix to capture the texture features of the non-text objects, which mainly include the local image entropy and the local standard deviation, setting the threshold value related to the size of the page, detecting the connected non-text object region in the graph of the page.

Step 320, filling the holes in the connected region with the morphological processing. In particular, the hole-filling algorithm based on the morphological erosion operator is used to fill up the holes in the connected region.

Step 322, detecting the bounding box of the connected region, and forming the bounding box of the non-text object connected region by region growing. In particular, the bounding box (the minimum bounding rectangle, serving as a scope corresponding to the non-text object connected region) of each detected non-text object connected region is calculated firstly, and then those bounding boxes, which are overlappingly intersected or whose adjacent distance is less than the preset distance, are undergone region growing, lastly calculating the final bounding box.

Step 324, deciding whether the bounding boxes should be merged. In particular, after the text layer and the non-text layer are processed respectively, some bounding boxes of the text regions or non-text regions are obtained respectively. Herein, whether some of the bounding boxes should be merged is determined by comparing these bounding boxes on distance, the deciding procedure including:

if the non-text connected objects of the non-text layer is intersected with the text-type bounding box of the text layer, or their distance is less than the preset distance, then merge these two bounding boxes;

if their distance is larger than a character spacing, then skip the union operation.

Step 326, depending on a union processing result of any two of the bounding boxes (either merged or not merged) to decide whether the result is converged, if yes, then move to step 328, otherwise return to step 324, such that all the bounding boxes are ensured to be undergone the union processing to achieve a precise composite graph segmentation.

Step 328, returning the final bounding box set, and storing as a file. In particular, when the bounding boxes have no more new union operation to be done, which means the algorithm converges, the bounding box information of the composite graph (the information determining the corresponding regions) is returned finally, and the corresponding primitive ID set forming the composite graph is stored as a XML file. Alternatively, the divided composite graph can also be stored in the form of image file, thereby avoiding the inefficiency problem occurred when managing a great number of primitive IDs.

Some embodiments are listed at below, to respectively exemplify the technical solution of the present invention in details.

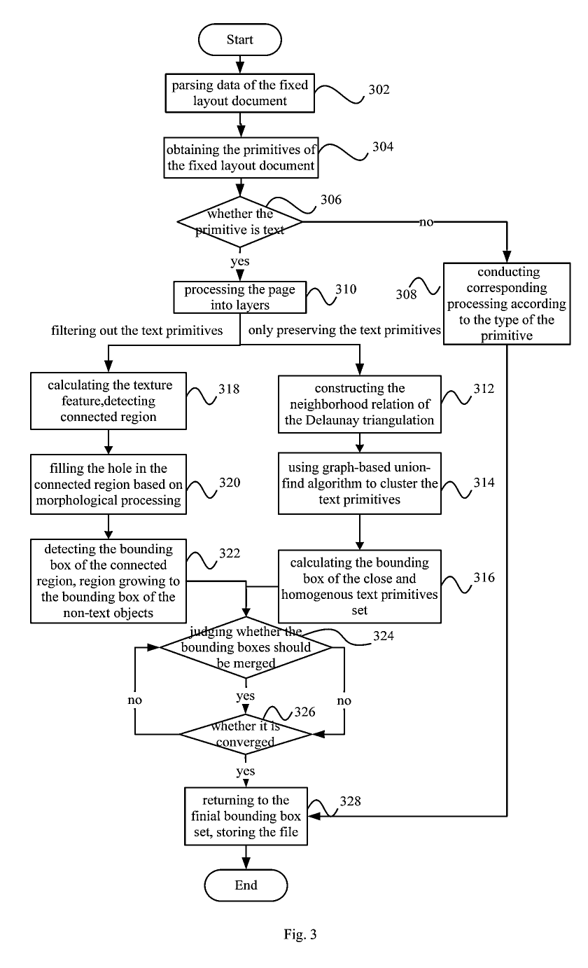

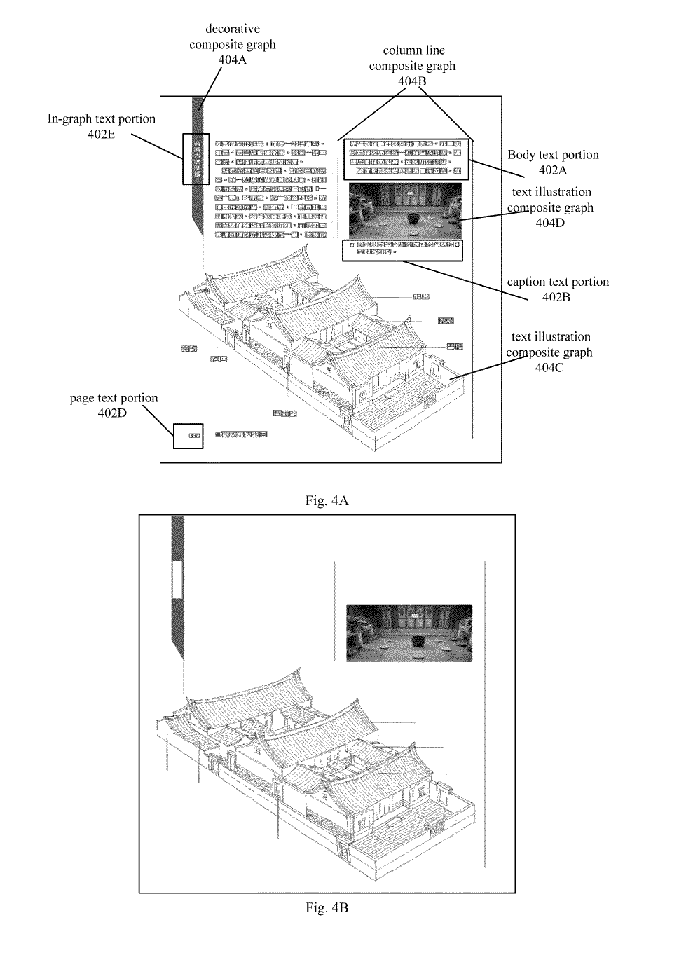

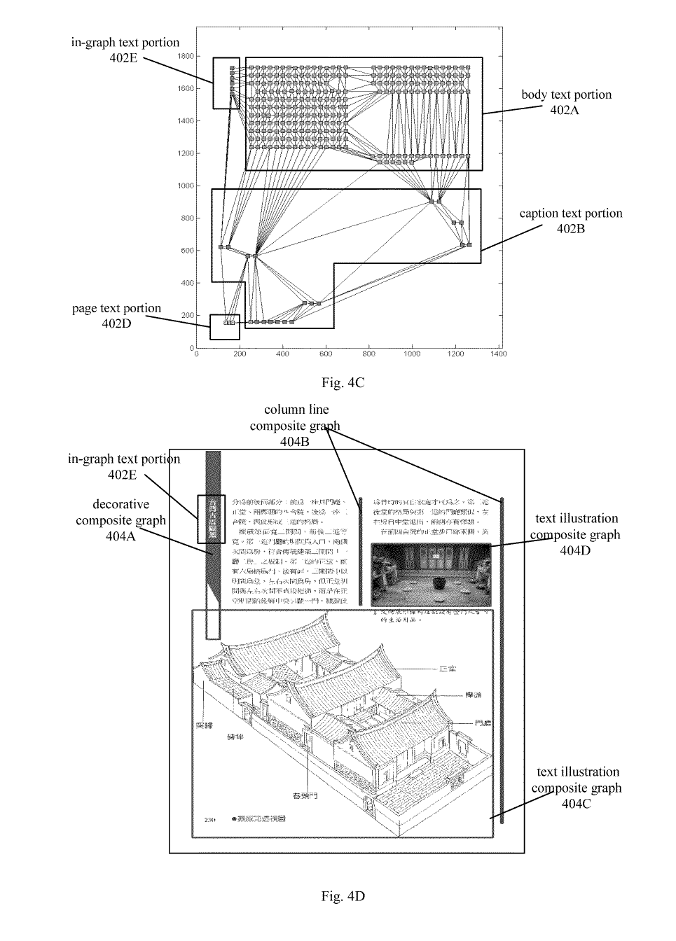

FIGS. 4A-4D are schematic diagrams for extracting composite graph in a fixed layout document according to one embodiment of the present invention.

As shown in the figure, a page with two columns in a book which is a fixed layout document in Chinese and titled “ [symbol] ” is taken for example. The figure includes: a body text portion 402A formed of text primitives, a caption text portion 402B, a page text portion 402D and a in-graph text portion 402E, as well as a decorative composite graph 404A formed of non-text primitives, a column line composite graph 404B, a text illustration composite graph 404C and a text illustration composite graph 404D. At below, the composite graph objects in the page will be partitioned according to the flow chart shown in FIG. 3.

At first, it is required to obtain all kinds of primitives in the layout document by a parsing engine, and then the path primitives are grouped to obtain the text layer only containing text primitives and the non-text layer only containing non-text primitives.

In particular, the text primitives embedded in the document are extracted, and the extracted text primitives in the page can be used to form the text layer; thereafter the text primitives are filtered out and the remaining non-text primitives form the non-text layer. As shown in FIG. 4A, the bounding boxes of all the words in the page are visibly shown; the page is redrawn to form the non-text layer by filtering out the text primitives in the page, as shown in FIG. 4B.

Thereafter, it is required to process the text layer and the non-text layer respectively. The processing steps are shown in FIG. 3 from step 312 to step 316, and from step 318 to step 322.

1. Regarding clustering the text layer, FIG. 4C shows the neighborhood relation of the text primitives constructed by taking the centroid of the bounding rectangle of the text primitives in the page as vertex and by using the Delaunay triangulation. The graph-based union-find algorithm is designed by taking the typeface information of the text primitives contained in the parsed layout document as feature, and the result of the text clustering is shown in different colors, as shown in FIG. 4C, the characters within the page are clustered into 4 classes, respectively belonging to the body text portion 402A, the caption text portion 402B, the page text portion 402D and the in-graph text portion 402E.

2. The non-text layer is undergone the connect-region detection based on the texture analysis and the morphological processing, and the connected region obtained therefrom is undergone the correlation analysis and the region growing, and the bounding box of the connected region after region growing is determined

3. The segmentation results of the text layer and the non-text layer are integrated. The finial segmentation result of the composite graph of the page is shown in FIG. 4D as follows. The decorative composite graph 404A on the left side of the page along with the in-graph text portion 402E contained therein is partitioned out accurately; the text illustration composite graph 404C at the lower place of the page contains a lot of path operations and text primitives surrounding it, which leads to a great trouble in segmentation, however it can also be partitioned accurately by using the method of the present invention; the column line composite graph 404B and grey scale image (the text illustration composite graph 404D) are both partitioned accurately. The segmentation results can be directly used in the reflowable layout application of the fixed layout document.

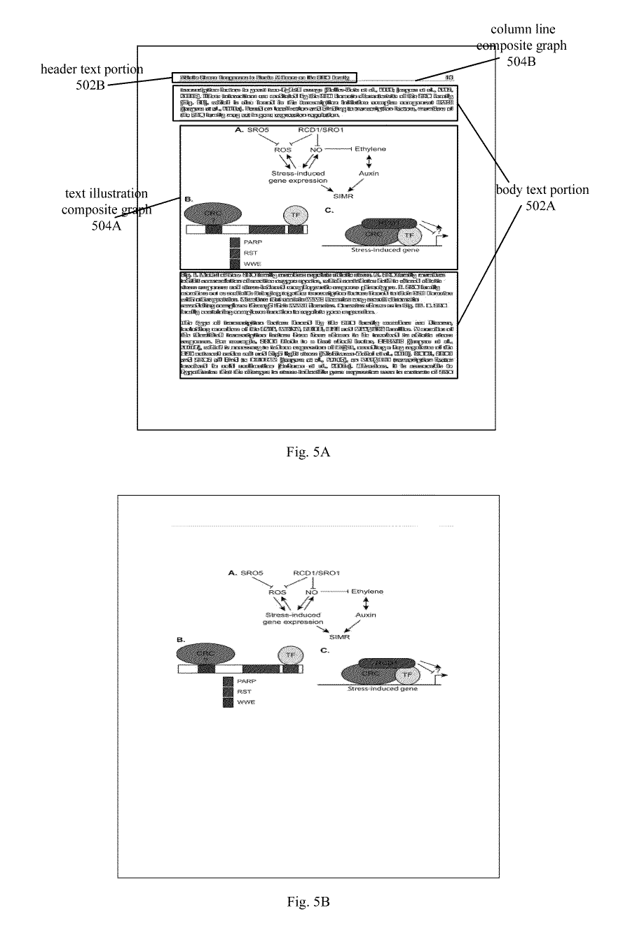

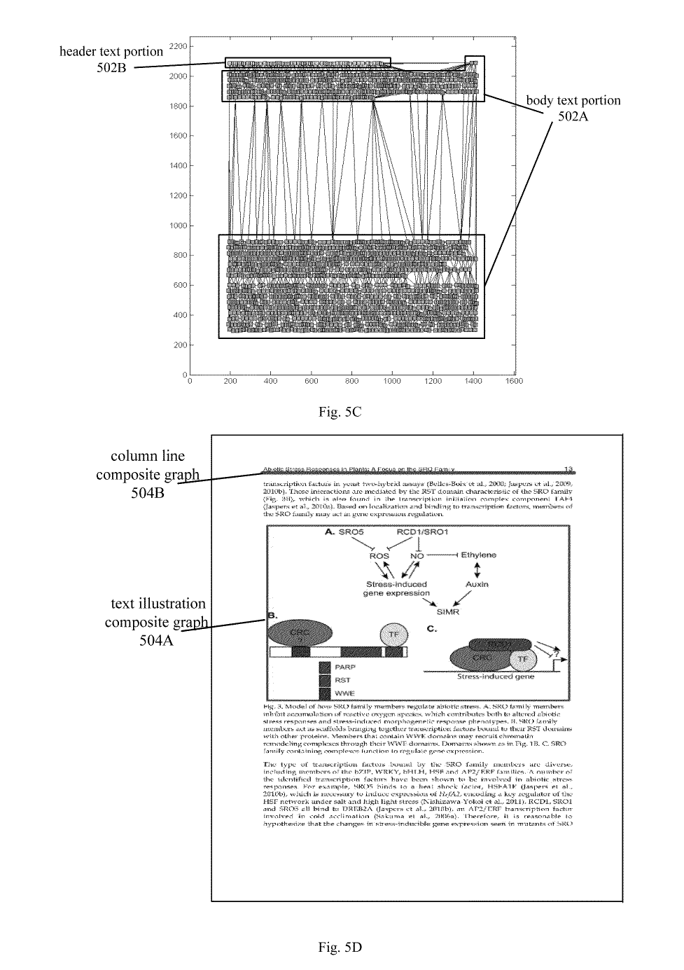

FIGS. 5A-5D are schematic diagrams for extracting composite graph in a fixed layout document according to another embodiment of the present invention.

As shown in the figure, taking a page with a single column in a book which is a fixed layout document in English and titled “Advances in Selected Plant Physiology Aspects” for example, it includes: a body text portion 502A formed of the text primitives and a header text portion 502B, as well as a text illustration composite graph 504A formed of the non-text primitives and a column line composite graph 504B. At below, the composite graph objects in the page will be partitioned according to the flow chart given in FIG. 3.

Firstly, it is required to obtain all kinds of primitives of the fixed layout document by a parsing engine, and then the path primitives are grouped to obtain a text layer only containing the text primitives and a non-text layer containing the rest non-text primitives.

In particular, the text primitives embedded in the document are extracted, and the extracted text primitives in the page can be used to form the text layer; thereafter the text primitives are filtered out and the remaining non-text primitives form the non-text layer. As shown in FIG. 5A, the bounding boxes of all the words in the page are visibly shown; the page is redrawn to form the non-text layer by filtering out the text primitives in the page, as shown in FIG. 5B.

Thereafter, it is required to process the text layer and the non-text layer respectively. The processing steps are shown in FIG. 3 from step 312 to step 316, and from step 318 to step 322.

1. Regarding clustering the text layer, FIG. 5C shows the neighborhood relation of the text primitives constructed by taking the centroid of the bounding rectangle of the text primitives in the page as vertex and by using the Delaunay triangulation. The graph-based union-find algorithm is designed by taking the typeface information of the text primitives contained in the parsed layout document as feature, and the result of the text clustering is shown in different colors, as shown in FIG. 5C, the characters within the page are clustered into 2 classes, respectively belonging to the body text portion 502A and the header text portion 502B.

2. The non-text layer is undergone the connect-region detection based on the texture analysis and the morphological processing, and the connected region obtained therefrom is undergone the correlation analysis and the region growing, and the bounding box of the connected region after region growing is determined

3. The segmentation results of the text layer and the non-text layer are integrated. The finial segmentation result of the composite graph of the page is shown in FIG. 5D as follows. The text illustration composite graph 504A in the middle of the page is formed of 3 scanned sub-images and the characters therein all belong to the scanned sub-images, and the composite graph consisting of these sub-images is accurately partitioned; the column line composite graph 504B at the top of the page is partitioned accurately. The segmentation results can be directly used in the reflowable layout application of the fixed layout document.

The disclosure provides a computer-readable medium having computer-executable instructions that, when executed by a computer, performs an extraction method for the composite graph in a fixed layout document, the method comprising: parsing the fixed layout document, determining the primitives constituting the fixed layout document and the types of said primitives; extracting text primitives to form a text layer, and using the rest non-text primitives to form a non-text layer; having the text layer and the non-text layer undergone page analyses respectively, so as to generate a text block in the text layer and a graph block in the non-text layer; determining the text block correlated with each said graph block, so as to merge them into a composite graph block; storing the identifiers of all primitives contained in the composite graph block.

The detailed technical solution of the present invention is described in combination with the figures in above. The present invention applies the graph-based page analysis technology in extraction of the structure information of the composite graph in a fixed layout document, and combines the image file processing technology with the intrinsic underlying structure information of the fixed layout document, so as to lay a foundation for an efficient and reliable smart analysis and understanding of document, and render a support for improving the dynamic real-time mixing of graph-text and multi-media information and for the robustness of cross-platform reading.

What are described above are merely preferred embodiments of the present invention, but do not limit the protection scope of the present invention. Various modifications or variations can be made to this invention by persons skilled in the art. Any modifications, substitutions, and improvements within the scope and spirit of this invention should be encompassed in the protection scope of this invention.

What is claimed:

1. An extraction device for the composite graph in a fixed layout document, the device comprising:
a document parsing unit, for parsing the fixed layout document, and determining the primitives of the fixed layout document and types of said primitives;
a layer generation unit, for extracting text primitives so as to form a text layer, and using the rest non-text primitives to form a non-text layer;
a page analysis unit, for processing the text layer and the non-text layer with page analyses respectively;
a block generation unit, for generating a text block in the text layer and a graph block in the non-text layer, based on the processing results of the page analyses conducted by the page analysis unit;
a correlation block determination unit, for determining text blocks correlating to every graph block and merging those correlated text blocks and graph blocks into a composite graph block;
an identifier storage unit, for storing the identifiers of all the primitives contained in the composite graph block.

2. The extraction device of claim 1 wherein said page analysis unit comprises:
a clustering process sub-unit, for clustering the text primitives in the text layer so as to classify the text primitives;
a text block generation sub-unit, in the case where there are many text primitives in the same class, for assembling said text primitives of the same class as a text primitive set and taking the minimum bounding rectangle of the text primitive set as one of the text blocks, when the corresponding minimum bounding rectangles intersect or the spacing distance thereof is less than the preset distance.

3. The extraction device of claim 1 wherein said page analysis unit comprises:
a texture feature obtaining sub-unit, for obtaining the texture features of the non-text primitives in the non-text layer;
a connect-region detection sub-unit, for detecting the connected non-text object regions in the non-text layer according to said texture features and a preset feature threshold;
a graph block generation sub-unit, regarding multiple said connected non-text object regions, for assembling said multiple connected non-text object regions as a region set and taking the minimum bounding rectangle of the region set as the graph block, when the corresponding minimum bounding rectangles intersect or the spacing distance thereof is less than the preset distance.

4. The extraction device of claim 3 wherein said page analysis unit further comprises:
a hole filling sub-unit, for filling the holes present in the connected non-text object regions.

5. The extraction device of claim 1 wherein said correlation block determination unit comprises:
a positional relation detection sub-unit, for detecting the positional relation between the graph block and the text block, wherein if the specified graph block intersects with at least one text block or the spacing distance between the specified graph block and the at least one text block is less than a preset distance, then the at least one text block is determined to be correlated to the specified graph block.

6. The extraction device of claim 1, further comprising:
an image generation unit, for generating image file with the composite graph blocks;
an image storage unit, for storing said image files.

7. An extraction method for the composite graph in a fixed layout document, the method comprising:
parsing the fixed layout document, determining the primitives constituting the fixed layout document and the types of said primitives;
extracting text primitives to form a text layer, and using the rest non-text primitives to form a non-text layer;
having the text layer and the non-text layer undergone page analyses respectively, so as to generate a text block in the text layer and a graph block in the non-text layer;
determining the text block correlated with each said graph block, so as to merge them into a composite graph block;
storing the identifiers of all primitives contained in the composite graph block.

8. The extraction method of claim 7 wherein processing the text layer with page analysis comprises:
clustering the text primitives in the text layer so as to classify the text primitives,
wherein in the case where there are many text primitives in the same class, assembling said text primitives of the same class as a text primitive set and taking the minimum bounding rectangle of the text primitive set as one of the text blocks, if the corresponding minimum bounding rectangles intersect or the spacing distance thereof is less than a preset distance.

9. The extraction method of claim 7 wherein processing the non-text layer with page analysis comprises:
obtaining the texture features of the non-text primitives in the non-text layer, and detecting the connected non-text object regions in the non-text layer according to a preset feature threshold,
wherein regarding multiple said connected non-text object regions, assembling said multiple connected non-text object regions as a region set and taking the minimum bounding rectangle of the region set as the graph block, if the corresponding minimum bounding rectangles intersect or the spacing distance thereof is less than a preset distance.

10. The extraction method of claim 7 further comprising:
filling the holes present in the connected non-text object regions.

11. The extraction method of claim 7 determining the text blocks correlated to each said graph block comprises:
detecting the positional relation between the graph block and the text block, if the specified graph block intersects with at least one text block or the spacing distance between the specified graph block and the at least one text block is less than the preset distance, then the at least one text block is determined to be correlated to the specified graph block.

12. The extraction method of claim 7 further comprising:
storing said composite graph block as image file.

13. The method of claim 9 further comprising a computer comprising one or more computer-readable media having computer-executable instructions that, when executed by the computer.

14. The method of claim 7 further comprising a computer-readable medium having computer-executable instructions that, executed by a computer.

15. The method of claim 7 further comprising an operating system embodied on a computer-readable medium having computer-executable instructions that, are executed by a computer.

16. Providing a computer-readable medium having computer-executable instructions that, when executed by a computer, performs an extraction method for the composite graph in a fixed layout document, the method comprising:
parsing the fixed layout document, determining the primitives constituting the fixed layout document and the types of said primitives;
extracting text primitives to form a text layer, and using the rest non-text primitives to form a non-text layer;
having the text layer and the non-text layer undergone page analyses respectively, so as to generate a text block in the text layer and a graph block in the non-text layer;
determining the text block correlated with each said graph block, so as to merge them into a composite graph block;
storing the identifiers of all primitives contained in the composite graph block.
